(19) United States
(12) Patent Application Publication
(10) Pub. No.: US 2006/0054417 A1
(43) Pub. Date: Mar. 16, 2006

(54) Gravity-fed lubricator for escalators or moving walks

(76) Inventor: Alexander Prenner, Pottsching (AT)

Correspondence Address: SCHWEITZER CORNMAN GROSS & BONDELL LLP, 292 MADISON AVENUE - 19th FLOOR, NEW YORK, NY, 10017, US

(21) Appl. No.: 11/225,366

(22) Filed: Sep. 13, 2005

(30) Foreign Application Priority Data
Sep. 13, 2004 (EP) 04405572.1

(51) Int. Cl. F16N 7/02

(52) U.S. Cl. 184/15.1

(57) ABSTRACT

A device for lubricating escalators or moving walks has a lubricant container, a lubricant supply line, and a control device. The lubricant container is arranged in such manner that lubricant moves out of the lubricant container to at least one lubrication point under the influence of gravity. A lubricant valve is located in the lubricant supply line. The control device is coupled to the valve and operates the valve in a requirements-related manner, in reliance upon installation-specific parameters of the escalator or moving walk.

The invention relates to a device for lubricating escalators or moving walks that have a lubricant container, a lubricant supply line, and a control device, the lubricant container being arranged in such manner that a lubricant moves from the lubricant container to at least one lubrication point under the influence of gravity, and that a lubricant valve is arranged in the lubricant supply line.

### BACKGROUND OF THE INVENTION

On escalators and moving walks there are parts that require regular lubrication. This applies particularly to the step chain and driving chain. Until now, this lubrication has been performed manually at regular intervals or by fully automatic lubrication systems.

In fully automatic lubrication systems the lubricant is transported to the lubrication points by a lubrication transporter in the form of a pump. In fully automatic lubrication systems the lubrication points are distributed in all spatial directions and supplied with lubricant through lubricant supply lines. In such systems, the position of the lubricant container is arbitrary. Fully automatic lubrication systems have a high consumption of lubricant, since the lubricant is delivered irrespective of the operating state. This has disadvantageous effects on costs and the environment.

Also known is transportation of the lubricant by the use of gravity. Such lubrication systems are also known as gravity-fed lubricators. In these lubricators, the lubrication points are situated below the lubricant container. Gravity is used to transport the lubricant from a lubricant container to the lubrication points. The quantity of lubricant is adjusted by dosing elements. These dosing elements adjust the flow of lubricant so that lubrication is continuous.

In the gravity-fed lubricators known to date, the flow of lubricant cannot be influenced, which means that lubrication also takes place when the escalator or moving walk is stationary. Moreover, such lubrication systems cannot take account of changing environmental conditions that require different quantities of lubricant. Furthermore, different lubrication requirements of the lubrication points cannot be realized with such systems. During the life cycle of an escalator or moving walk, different lubrication cycles have to be taken into account. No difference can be made between an initial lubrication and a maintenance lubrication or a short-term continuity lubrication.

From JP 05319767 A a lubrication system for an escalator has become known. A solenoid valve is arranged between a lubricant tank and a lubricant supply line. The solenoid valve is operated by means of a battery. A time controller controls the solenoid valve independent of the operating state.

From JP 07076481 an automatic lubrication system for an escalator is known. Disclosed is detection of rain by means of a rain sensor and replacement of the oil washed out by rainwater. When rain falls, a lubricant pump is started that initiates lubrication. By this means the oil washed out of the escalator chain can be replaced so that the chain is not subjected to increased wear because of oil being washed out. No account is taken of whether the escalator is stationary, or for how many operating hours it has already been operated.

Accordingly, it is an objective of the present invention to provide a device for lubricating escalators and moving walks in which the flow of lubricant can be controlled according to need.

### BRIEF DESCRIPTION OF THE INVENTION

In accordance with the foregoing, the present invention is based on the premise of an escalator or moving walk being operated with different settings. These different settings are contained in installation-specific parameters and are different for every escalator. The control system that controls the operation of the escalator or moving walk knows these installation-specific parameters, which are in the form of data that are stored in the control device. Installation-specific parameters can contain both fixed and variable parameters of the respective escalator or moving walk.

Foreseen according to the invention is that the device has a lubricant container that is arranged above one or more lubrication points so that the lubricant always moves to the lubrication points under the influence of gravity. Inserted in the lubricant supply line is a switchable lubricant valve. When the lubricant valve is closed, the flow of lubricant is interrupted. The control system that also serves to control the escalator or moving walk in accordance with the installation-specific parameters of the escalator or moving walk also utilizes the installation-specific parameters to open or close the lubricant valve according to the required lubrication.

During operation, continuous lubrication is generally required. However, following initial installation of the escalator, or after an overhaul, more extensive lubrication is required. Such requirements-related lubrications cannot be realized with lubrication systems according to the present state of the art. Installation-specific parameters such as operating time of the escalator, operating mode of the escalator, or the time since the last maintenance, can be used to control the lubrication in accordance with the present invention. One of the installation-specific parameters is the age of the escalator, increasing age generally requiring longer lubrication. Further installation-specific parameters are the speed of the escalator or moving walk, the normal ambient temperature and air humidity, as well as the type of operation (high utilization, low utilization) and the location (outdoors or indoors). The length and gradient, or inclination, of the escalator or moving walk, as well as its use and operating period, must be taken into account in its lubrication. The lubricant used (e.g. thin or viscous oil) also has an influence on the lubrication. The characteristics of the lubricant used can also be stored in the installation-specific parameters and taken into account for controlling lubrication.

The device according to the invention enables effective, inexpensive and efficient use of lubricant. Costs are thereby reduced and the environment protected. Realization of requirements-related lubrication with a gravity-fed lubricator according to the invention is particularly advantageous since no additional energy is needed to transport the lubricant.

An escalator or moving walk is also operated in different operating states. An escalator stops automatically when not being used and need not be lubricated when stationary. If lubrication were controlled entirely by time, the escalator would still be lubricated when stationary. A further operating state that has a considerable influence on the lubrication is rain that falls on the escalator and can wash the lubricant away. However, even when rain is falling, lubrication is only necessary if the escalator is moving. Account must also be taken of temperature fluctuations, since lubrication must not take place at low temperatures. To perform and ensure requirements-related lubrication, it is very important to consider not only the installation-specific parameters but also the momentary operating state.

A further advantageous embodiment of the installation envisages the lubricant valve taking the form of a solenoid valve and the quantity of lubricant that is supplied to the lubrication point being adjusted via the time for which the lubricant valve is open. This is a very simple embodiment of the invention, since the lubricant valve knows only two states, in which it is either completely open or completely closed. The length of time for which the lubricant valve is open can be used to adjust the quantity of lubricant.

In a further exemplary embodiment of the invention, the control device can continuously open or close the lubricant supply line via the lubricant valve. The lubricant quantity can be adjusted by the respective degree of opening of the lubricant valve.

A further advantageous embodiment of the invention envisages the flow of lubricant to several lubrication points being controlled via a lubricant valve. This is especially practical if the lubrication points have approximately identical requirements for lubricant.

A further advantageous embodiment envisages that when there are multiple lubrication points, multiple lubricant valves are connected to the lubricant container, the control device controlling the multiple lubricant valves depending on the requirements of the respective lubrication points. This embodiment can take account of the different requirements of the individual lubrication points. For example, a lubrication point that is exposed to high air humidity or rain may be supplied with more lubricant. On the other hand, a lubrication point that is not affected by rainwater is supplied with less lubricant, through the lubricant valve being opened either to a lesser degree, or only for a short time.

In yet another advantageous embodiment of the invention, the control device is connected to a memory in which the installation-specific parameters of the escalator or moving walk are stored. By means of these installation-specific parameters, the control device can determine at what times, or at what intervals, lubrication of the respective lubrication points on the escalator or moving walk must take place. It may be necessary, for example, for an escalator that has been running continuously for a certain length of time that exceeds a certain threshold value to be lubricated more extensively. This is then recognized by the control device. The intervals between the more extensive lubrications can vary with the age of the escalator. For example, an escalator in a department store is subjected to fewer fluctuations in temperature than an escalator at a railroad station that operates at least partly in the open air. This means that, for an escalator in a department store, less attention need be given to the current temperature when controlling the lubrication. The same applies to air humidity, operating period, operating load, and use.

A further advantageous embodiment envisages the control device being connected to at least one sensor that detects an operating state of the escalator or moving walk. A temperature sensor and a humidity sensor that register the respective current ambient conditions such as temperature and humidity for the purpose of controlling the lubrication depending upon them are particularly well adapted for such a purpose. The temperature and humidity values that are registered can be used along with the installation-specific parameters to control the lubrication.

It can be advantageous for the installation-specific parameters to include the running time, age, speed, gradient or inclination, length and width, as well as a base temperature and/or base air humidity of the escalator or moving walk. The operating states may include, among others, a movement direction (up or down), a current temperature, a current air humidity, a maintenance mode, and/or an initial installation mode of the escalator or moving walk.

In an advantageous embodiment, the control device opens the lubricant valve longer after an initial installation or overhaul of the escalator or moving walk than for a maintenance lubrication.

### BRIEF DESCRIPTION OF THE DRAWINGS

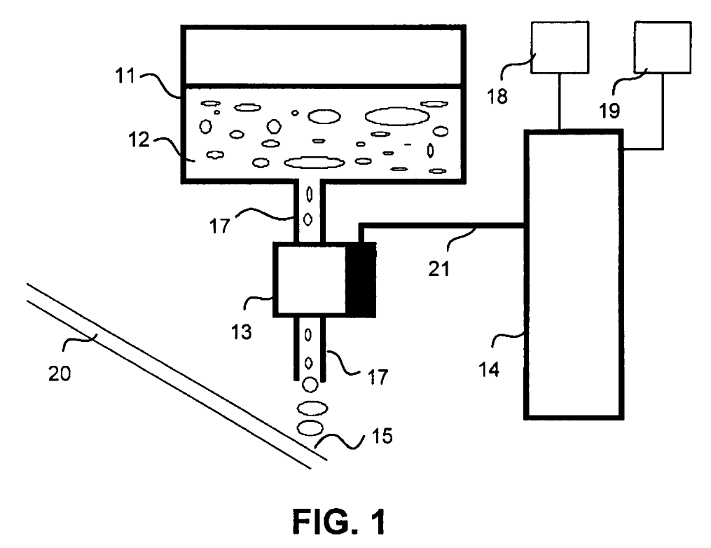

There follows below a more detailed explanation of the invention through reference to an exemplary embodiment that is illustrated diagrammatically in the drawing (FIG. 1) that presents a diagrammatic representation of a device according to the invention for lubricating escalators or moving walks.

### DETAILED DESCRIPTION OF THE INVENTION

An escalator or moving walk is indicated by reference number 20. A lubricant container 11 is filled with lubricant 12. The lubricant 12 is passed through a lubricant supply line 17 to a lubricant valve 13. The lubricant supply line 17 terminates at a lubrication point 15 in the area of the escalator 20. The lubricant valve 13 is connected via a control line 21 to a control device 14. The control device 14 is connected to a memory 18 in which the installation-specific parameters are stored. Also provided is a sensor 19 that registers an operating or ambient state of the escalator 20 which it transmits to the control device 14. Multiple sensors 19 that register additional states can also be provided.

The functioning of the device is as follows. The lubricant 12 flows out of the lubricant container 11 through the lubricant supply line 17 to the solenoid valve 13 and from the solenoid valve 13 flows further to the lubrication point 15. The force that acts on the lubricant 12 is gravity or air pressure. The flow of lubricant is interrupted when the lubricant valve 13 is closed, but not when the lubricant valve 13 is open. Control of the lubricant valve 13 takes place by means of the control device 14. The control device 14 may be an integral component of the escalator or moving walk control, as a result of which all installation-specific parameters and operating states are available that are, for example, stored in the memory 18. The lubricant quantity Q is mainly determined by the time t for which the lubricant valve 13 is open. The longer the lubricant valve 13 is open, the more lubricant 12 reaches the lubrication point 15. Lubrication intervals can thus be optimally adapted to the operating state of the escalator or moving walk 20.

Multiple lubricant supply lines 17 can be provided in conjunction with lubricant valve 13 to supply multiple lubrication points 15. However, this is not shown in FIG. 1. Also not shown in FIG. 1 is the provision of multiple lubrication valves 13 with corresponding lubrication supply lines 17 that supply lubricant 12 to multiple lubrication points 15.

Use of the lubricant valve 13 with requirements-related control allows the lubricant quantity Q to be individually controlled. The quantity of lubricant Q depends on the time t for which the lubricant valve 13 is open and the rate q at which lubricant flows through it according to the equation Q=q·t.

The control device 14 knows the installation-specific parameters and operating states with which the lubricant quantity Q can be optimally controlled. For example, by means of the control device 14, lubrication of the lubrication point 15 can only be carried out on an escalator 20 that is moving and/or in operation. Control of the lubricant valve 13 is especially possible by means of a time window or time interval. Should an escalator 20 be stopped during the lubrication process, the lubrication operation is interrupted, and resumed the next time the escalator 20 is started. Since lubrication takes place depending on the number of service hours, the required lubrication service intervals can complied with.

It is also possible for the control device 14 to recognize that an initial installation or overhaul of an escalator or moving walk 20 was undertaken that makes an extended initial lubrication necessary and, on completion of the initial lubrication, adjusts the lubrication valve 13 so that an adapted maintenance lubrication for normal operation of the escalator or moving walk 20 is realized.

Irrespective of the particular embodiment according to the invention employed, when servicing the escalator or moving walk 20, the control device 14 can allow lubrication to be initiated and performed manually or a maintenance lubrication to be set or conducted.

By optimal adaptation of the lubricant quantity Q to the requirements of the lubrication point 15, lubricant 12 can be saved, with the result that the reduced use of lubricant has a positive effect on the environment and saves lubricant expenditure. Through embodiment of the gravity-fed lubricator with requirements-related control according to the invention, energy consumption can be minimized when the need for lubrication is minimized. It is particularly advantageous to use the installation-specific parameters present in the control of the escalator or moving walk 20 to control lubrication. It is not necessary to provide a control for lubrication. In such a case, it may not be necessary to provide a separate control for lubrication, as the lubrication control can be integrated in the escalator control.

I claim:

1. A device for lubricating escalators or moving walks, comprising a lubricant container, a lubricant supply line connected to the lubricant container, at least one lubricant valve located in the supply line, and a control device coupled to the valve, the lubricant container being located arranged in such manner that a lubricant moves out of the lubricant container through the supply line to at least one lubrication point under the influence of gravity, the control device controlling the at least one lubricant valve in dependence on installation-specific parameters of the escalator or moving walk.

2. The device according to claim 1, wherein the installation-specific parameters include operating states of the escalator or moving-walk.

3. The device according to claim 1 or 2, wherein the at least one lubricant valve is a solenoid valve and the control device comprises means for adjusting a quantity of lubricant supplied to at least one of the at least one lubrication points via the time for which a lubricant valve is open.

4. The device according to claim 1 or 2, characterized in that the control device can continuously control a degree of lubricant valve opening whereby the quantity of lubricant is adjustable via the degree of opening.

5. The device according to claim 1 or 2, characterized in that multiple lubrication points are connected to at least one of the at least one lubricant valve, the control device controlling the at least one lubricant valve individually depending on the lubrication points associated with each of the at least one lubricant valve.

6. The device according to claim 1 or 2, characterized in that the control device is coupled to a memory in which installation-specific parameters of the escalator or moving walk are stored.

7. The device according to claim 1 or 2, characterized in that the control device is coupled to at least one sensor that registers an operating state of the escalator or moving walk.

8. The device according to claim 1 or 2, characterized in that the installation-specific parameters include the operating time, operational use, mode of installation, age, speed, gradient or inclination, length, width, base temperature, and/or base air humidity of the escalator or moving walk.

9. The device according to claim 2, characterized in that the operating states include a movement direction, a current ambient temperature, a current ambient air humidity, a maintenance mode, and/or an initial installation mode of the escalator or moving walk.

10. The device according to claim 1 or 2, characterized in that the control device opens the at least one lubricant valve for a longer interval after an initial installation or overhaul of the escalator or moving walk than for a maintenance lubrication.
